(19) United States
(12) Patent Application Publication
(10) Pub. No.: US 2022/0057533 A1
(43) Pub. Date: Feb. 24, 2022

(54) FLEXIBLE SUBSTRATE CHIP-ON FLEX REPAIR

(71) Applicant: CARESTREAM HEALTH, INC., Rochester, NY (US)

(72) Inventors: Gregory N. HEILER, Hilton, NY (US); Timothy J. WOJCIK, Rochester, NY (US); Ravi K. MRUTHYUNJAYA, Penfield, NY (US); Timothy J. TREDWELL, Fairport, NY (US)

(21) Appl. No.: 16/090,910

(22) PCT Filed: May 8, 2017
(86) PCT No.: PCT/US2017/031522

§ 371 Date: Oct. 3, 2018

Related U.S. Application Data
(60) Provisional application No. 62/333,887, filed on May 10, 2016.

(51) Int. Cl. G01T 1/24

(52) U.S. Cl. CPC G01T 1/241; G01T 1/247

(57) ABSTRACT

A digital radiographic detector includes redundant bonding pads formed on the array substrate and electrically connected to the array of photosensors. A plurality of COFs are each electrically connected to one of the bonding pads. A repair may be performed by removing a bond pad and reconnecting a corresponding COF to a redundant bond pad. A PCB including array read out electronics is electrically connected to the plurality of COFs.

### BACKGROUND OF THE INVENTION

The subject matter disclosed herein relates to digital radiographic detector panels. In particular, to manufacturing flexible substrate DR detectors.

When an x-ray detector is assembled with a flexible substrate sensor array, it may be more difficult to replace the Chip-on-Film (COF) electrical connections to the read-out circuitry as compared with a glass-based sensor array. The process to remove the COF from the flex substrate sensor array, in a manner that allows rebonding of the COF may be problematic. The flexible substrate sensor array COF land and connection traces can be damaged though the mechanical and chemical removal and clean process. When this happens, the flexible substrate sensor array x-ray detector may be rendered unusable.

On glass based sensor arrays the gate drivers and read out IC COF's are anisotropic conductive film (ACF) bonded to the array connection pads in an area adjacent to the image sensor array. In the case of flexible polyimide based sensor arrays, replacing one of the COFs may not be easy. It may be necessary rework ACF connections to polyimide because the pad adhesion to the polyimide is more fragile than those being used on glass substrates, and so it may be inadvertently destroyed. In the replacement procedure, the COF bond pads are heated, pulled off the flex circuit, sensor pads are cleaned, and another COF is reattached.

The flexible image sensor substrate may be fabricated so the COF pads extend from the main body of the sensor array. Redundant COF pads may be included on this extension so as to allow a simple cut to remove the outer COF bond pads, leaving the inner set of redundant bonding pads. To keep the same COF length between the x-ray detector and the printed wiring boards (PWB), redundant pads may also be used on the PWB or PCB.

### BRIEF DESCRIPTION OF THE INVENTION

A digital radiographic detector includes redundant bonding pads formed on the array substrate and electrically connected to the array of photosensors. A plurality of COFs are each electrically connected to one of the bonding pads. A repair may be performed by removing a bond pad and reconnecting a corresponding COF to a redundant bond pad. A PCB including array read out electronics is electrically connected to the plurality of COFs. An advantage that may be realized in the practice of some embodiments disclosed herein is a simpler and inexpensive repair procedure.

In one embodiment, a digital detector includes an array of photosensors formed on a substrate. A plurality of pairs of bonding pads on the substrate are each electrically connected to a same portion of the array of photosensors. A plurality of COFs are each electrically connectible to only one bonding pad in each pair of bonding pads and readout electronics are electrically connected to the plurality of COFs to control a readout from the array of photosensors and to receive image data from the array of photosensors.

In one embodiment, a method of electrically connecting an array of photosensors to a COF includes forming the array of photosensors on a substrate, forming a first bonding pad and a second bonding pad on the substrate, the first and second bonding pads electrically connected to a first portion of the photosensors, electrically connecting the first bonding pad to a COF, detaching the COF from the first bonding pad, removing the first bonding pad from the substrate, and electrically connecting the second bonding pad to the COF.

In another embodiment, a method of electrically connecting an array of photosensors to COFs includes using bonding pads that are connected to the photosensors, electrically connecting the bonding pad to the COF, detaching the COF from the bonding pad, removing a portion of the bonding pad, and electrically connecting the COF to a remaining portion of the bonding pad.

In another embodiment, a digital detector includes an array of photosensors formed on a substrate and a plurality of array bonding pads are formed on the substrate. Each array bonding pad is electrically connected to a portion of the array of photosensors. A printed circuit board has a plurality of readout bonding pads each electrically connected to readout electronics on the printed circuit board. A plurality of COFs each has a first COF bonding pad proximate a first end of the COF configured to be electrically connected to only one array bonding pad. The plurality of COFs each also has second and third COF bonding pads proximate a second end of the COF opposite the first end. The second and third bonding pads are configured such that only one is connectible to only one readout bonding pad.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic perspective view of an exemplary x-ray system;

FIG. 2 is a schematic diagram of a photosensor array in a radiographic detector;

FIG. 3 is a diagram of a DR detector;

FIG. 4 is a cross-section view of the DR detector of FIG. 3;

FIG. 5 is a schematic diagram in top view of a portion of an exemplary prior art x-ray detector using a glass based substrate;

FIGS. 6A-6B are a schematic partial close-up top view and a schematic side view, respectively, of the exemplary glass based x-ray detector of FIG. 5;

FIG. 7A is a partial schematic close-up top view of an exemplary flexible substrate based x-ray detector;

FIGS. 7B-7C are schematic side views of a reattachment method for the exemplary flexible substrate based x-ray detector of FIG. 7A;

FIGS. 8A-8B are schematic side views of another reattachment method for an exemplary flexible substrate based x-ray detector;

FIGS. 9A-9B are schematic side views of another reattachment method for an exemplary flexible substrate based x-ray detector, and FIG. 9C is a schematic top view of the reattachment method of FIGS. 9A-9B;

FIGS. 10A-10C show an exemplary repair embodiment of a bond pad; and

FIGS. 11A-11C show alternative embodiments for cutting bond pads.

### DETAILED DESCRIPTION OF THE INVENTION

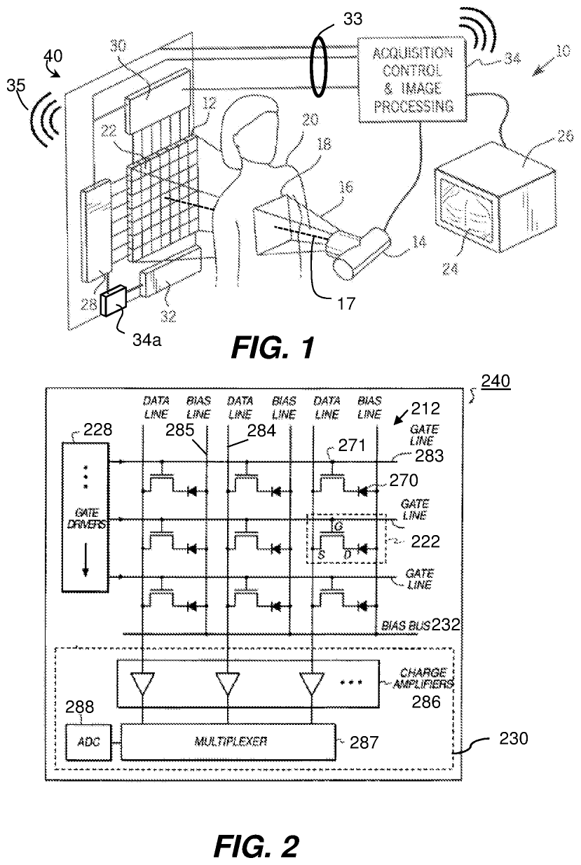

FIG. 1 is a perspective view of a digital radiographic (DR) imaging system 10 that may include a generally curved or planar DR detector 40 (shown in a planar embodiment and without a housing for clarity of description), an x-ray source 14 configured to generate radiographic energy (x-ray radiation), and a digital monitor, or electronic display, 26 configured to display images captured by the DR detector 40, according to one embodiment. The DR detector 40 may include a two dimensional array 12 of detector cells 22 (photosensors), arranged in electronically addressable rows and columns. The DR detector 40 may be positioned to receive x-rays 16 passing through a subject 20 during a radiographic energy exposure, or radiographic energy pulse, emitted by the x-ray source 14. As shown in FIG. 1, the radiographic imaging system 10 may use an x-ray source 14 that emits collimated x-rays 16, e.g. an x-ray beam, selectively aimed at and passing through a preselected region 18 of the subject 20. The x-ray beam 16 may be attenuated by varying degrees along its plurality of rays according to the internal structure of the subject 20, which attenuated rays are detected by the array 12 of photosensitive detector cells 22. The curved or planar DR detector 40 is positioned, as much as possible, in a perpendicular relation to a substantially central ray 17 of the plurality of rays 16 emitted by the x-ray source 14. In a curved array embodiment, the source 14 may be centrally positioned such that a larger percentage, or all, of the photosensitive detector cells are positioned perpendicular to incoming x-rays from the centrally positioned source 14. The array 12 of individual photosensitive cells (pixels) 22 may be electronically addressed (scanned) by their position according to column and row. As used herein, the terms “column” and “row” refer to the vertical and horizontal arrangement of the photo sensor cells 22 and, for clarity of description, it will be assumed that the rows extend horizontally and the columns extend vertically. However, the orientation of the columns and rows is arbitrary and does not limit the scope of any embodiments disclosed herein. Furthermore, the term “subject” may be illustrated as a human patient in the description of FIG. 1, however, a subject of a DR imaging system, as the term is used herein, may be a human, an animal, an inanimate object, or a portion thereof.

In one exemplary embodiment, the rows of photosensitive cells 22 may be scanned one or more at a time by electronic scanning circuit 28 so that the exposure data from the array 12 may be transmitted to electronic read-out circuit 30. Each photosensitive cell 22 may independently store a charge proportional to an intensity, or energy level, of the attenuated radiographic radiation, or x-rays, received and absorbed in the cell. Thus, each photosensitive cell, when read-out, provides information defining a pixel of a radiographic image 24, e.g. a brightness level or an amount of energy absorbed by the pixel, that may be digitally decoded by image processing electronics 34 and transmitted to be displayed by the digital monitor 26 for viewing by a user. An electronic bias circuit 32 is electrically connected to the two-dimensional detector array 12 to provide a bias voltage to each of the photosensitive cells 22.

Each of the bias circuit 32, the scanning circuit 28, and the read-out circuit 30, may communicate with an acquisition control and image processing unit 34 over a connected cable 33 (wired), or the DR detector 40 and the acquisition control and image processing unit 34 may be equipped with a wireless transmitter and receiver to transmit radiographic image data wirelessly 35 to the acquisition control and image processing unit 34. The acquisition control and image processing unit 34 may include a processor and electronic memory (not shown) to control operations of the DR detector 40 as described herein, including control of circuits 28, 30, and 32, for example, by use of programmed instructions, and to store and process image data. The acquisition control and image processing unit 34 may also be used to control activation of the x-ray source 14 during a radiographic exposure, controlling an x-ray tube electric current magnitude, and thus the fluence of x-rays in x-ray beam 16, and/or the x-ray tube voltage, and thus the energy level of the x-rays in x-ray beam 16. A portion or all of the acquisition control and image processing unit 34 functions may reside in the detector 40 in an on-board processing system 34a which may include a processor and electronic memory to control operations of the DR detector 40 as described herein, including control of circuits 28, 30, and 32, by use of programmed instructions, and to store and process image data similar to the functions of standalone acquisition control and image processing system 34. The image processing system may perform image acquisition and image disposition functions as described herein. The image processing system 34a may control image transmission and image processing and image correction on board the detector 40 based on instructions or other commands transmitted from the acquisition control and image processing unit 34, and transmit corrected digital image data therefrom. Alternatively, acquisition control and image processing unit 34 may receive raw image data from the detector 40 and process the image data and store it, or it may store raw unprocessed image data in local memory, or in remotely accessible memory.

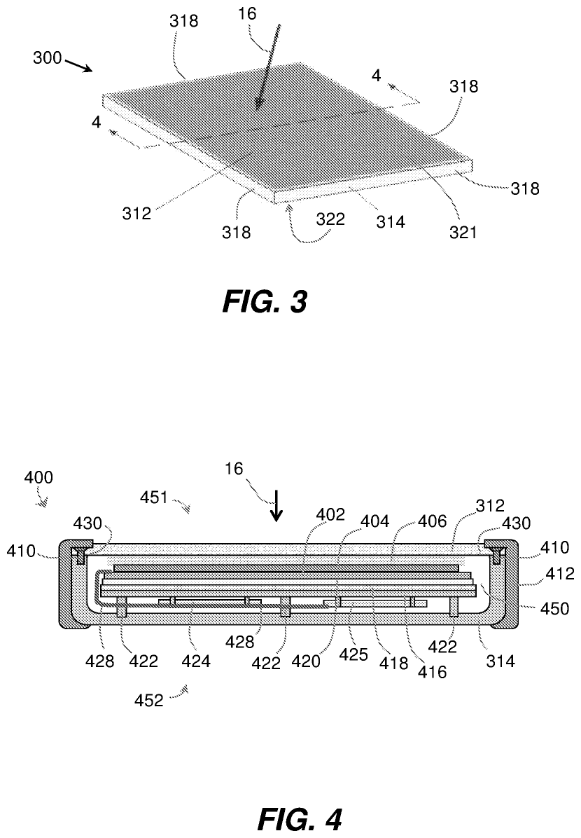

With regard to a direct detection embodiment of DR detector 40, the photosensitive cells 22 may each include a sensing element sensitive to x-rays, i.e. it absorbs x-rays and generates an amount of charge carriers in proportion to a magnitude of the absorbed x-ray energy. A switching element may be configured to be selectively activated to read out the charge level of a corresponding x-ray sensing element. With regard to an indirect detection embodiment of DR detector 40, photosensitive cells 22 may each include a sensing element sensitive to light rays in the visible spectrum, i.e. it absorbs light rays and generates an amount of charge carriers in proportion to a magnitude of the absorbed light energy, and a switching element that is selectively activated to read the charge level of the corresponding sensing element. A scintillator, or wavelength converter, may be disposed over the light sensitive sensing elements to convert incident x-ray radiographic energy to visible light energy. Thus, in the embodiments disclosed herein, it should be noted that the DR detector 40 (or DR detector 300 in FIG. 3 or DR detector 400 in FIG. 4) may include an indirect or direct type of DR detector.

Examples of sensing elements used in sensing array 12 include various types of photoelectric conversion devices (e.g., photosensors) such as photodiodes (P-N or PIN diodes), photo-capacitors (MIS), photo-transistors or photoconductors. Examples of switching elements used for signal read-out include a-Si TFTs, oxide TFTs, MOS transistors, bipolar transistors and other p-n junction components.

FIG. 2 is a schematic diagram 240 of a portion of a two-dimensional array 12 for a DR detector 40. The array of photosensor cells 212, whose operation may be consistent with the photosensor array 12 described above, may include a number of hydrogenated amorphous silicon (a-Si:H) n-i-p photodiodes 270 and thin film transistors (TFTs) 271 formed as field effect transistors (FETs) each having gate (G), source (S), and drain (D) terminals. In embodiments of DR detector 40 disclosed herein, such as a multilayer DR detector (400 of FIG. 4), the two-dimensional array of photosensor cells 12 may be formed in a flexible device layer, such as a polyimide layer, that abuts adjacent layers of the DR detector structure, which adjacent layers may include a rigid glass layer or a flexible polyimide layer or a layer including carbon fiber without any adjacent rigid layers. A plurality of gate driver circuits 228 may be electrically connected to a plurality of gate lines 283 which control a voltage applied to the gates of TFTs 271, a plurality of readout circuits 230 may be electrically connected to data lines 284, and a plurality of bias lines 285 may be electrically connected to a bias line bus or a variable bias reference voltage line 232 which controls a voltage applied to the photodiodes 270. Charge amplifiers 286 may be electrically connected to the data lines 284 to receive signals therefrom. Outputs from the charge amplifiers 286 may be electrically connected to a multiplexer 287, such as an analog multiplexer, then to an analog-to-digital converter (ADC) 288, or they may be directly connected to the ADC, to stream out the digital radiographic image data at desired rates. In one embodiment, the schematic diagram of FIG. 2 may represent a portion of a DR detector 40 such as an a-Si:H based indirect flat panel, curved panel, or flexible panel imager.

Incident x-rays, or x-ray photons, 16 are converted to optical photons, or light rays, by a scintillator, which light rays are subsequently converted to electron-hole pairs, or charges, upon impacting the a-Si:H n-i-p photodiodes 270. In one embodiment, an exemplary detector cell 222, which may be equivalently referred to herein as a pixel, may include a photodiode 270 having its anode electrically connected to a bias line 285 and its cathode electrically connected to the drain (D) of TFT 271. The bias reference voltage line 232 can control a bias voltage of the photodiodes 270 at each of the detector cells 222. The charge capacity of each of the photodiodes 270 is a function of its bias voltage and its capacitance. In general, a reverse bias voltage, e.g. a negative voltage, may be applied to the bias lines 285 to create an electric field (and hence a depletion region) across the pn junction of each of the photodiodes 270 to enhance its collection efficiency for the charges generated by incident light rays. The image signal represented by the array of photosensor cells 212 may be integrated by the photodiodes while their associated TFTs 271 are held in a non-conducting (off) state, for example, by maintaining the gate lines 283 at a negative voltage via the gate driver circuits 228. The photosensor cell array 212 may be read out by sequentially switching rows of the TFTs 271 to a conducting (on) state by means of the gate driver circuits 228. When a row of the pixels 22 is switched to a conducting state, for example by applying a positive voltage to the corresponding gate line 283, collected charge from the photodiode in those pixels may be transferred along data lines 284 and integrated by the external charge amplifier circuits 286. The row may then be switched back to a non-conducting state, and the process is repeated for each row until the entire array of photosensor cells 212 has been read out. The integrated signal outputs are transferred from the external charge amplifiers 286 to an analog-to-digital converter (ADC) 288 using a parallel-to-serial converter, such as multiplexer 287, which together comprise read-out circuit 230.

This digital image information may be subsequently processed by image processing system 34 to yield a digital image which may then be digitally stored and immediately displayed on monitor 26, or it may be displayed at a later time by accessing the digital electronic memory containing the stored image. The flat panel DR detector 40 having an imaging array as described with reference to FIG. 2 is capable of both single-shot (e.g., static, radiographic) and continuous (e.g., fluoroscopic) image acquisition.

FIG. 3 shows a perspective view of an exemplary prior art generally rectangular, planar, portable wireless DR detector 300 according to an embodiment of DR detector 40 disclosed herein. The DR detector 300 may include a flexible substrate to allow the DR detector to capture radiographic images in a curved orientation. The flexible substrate may be fabricated in a permanent curved orientation, or it may remain flexible throughout its life to provide an adjustable curvature in two or three dimensions, as desired. The DR detector 300 may include a similarly flexible housing portion 314 that surrounds a multilayer structure comprising a flexible photosensor array portion 22 of the DR detector 300. The housing portion 314 of the DR detector 300 may include a continuous, rigid or flexible, x-ray opaque material or, as used synonymously herein a radio-opaque material, surrounding an interior volume of the DR detector 300. The housing portion 314 may include four flexible edges 318, extending between the top side 321 and the bottom side 322, and arranged substantially orthogonally in relation to the top and bottom sides 321, 322. The bottom side 322 may be continuous with the four edges and disposed opposite the top side 321 of the DR detector 300. The top side 321 comprises a top cover 312 attached to the housing portion 314 which, together with the housing portion 314, substantially encloses the multilayer structure in the interior volume of the DR detector 300. The top cover 312 may be attached to the housing 314 to form a seal therebetween, and be made of a material that passes x-rays 16 without significant attenuation thereof, i.e., an x-ray transmissive material or, as used synonymously herein, a radiolucent material, such as a carbon fiber plastic, polymeric, or other plastic based material.

With reference to FIG. 4, there is illustrated in schematic form an exemplary cross-section view along section 4-4 of the exemplary embodiment of the DR detector 300 (FIG. 3). For spatial reference purposes, one major surface of the DR detector 400 may be referred to as the top side 451 and a second major surface may be referred to as the bottom side 452, as used herein. The multilayer structure may be disposed within the interior volume 450 enclosed by the housing 314 and top cover 312 and may include a flexible curved or planar scintillator layer 404 over a curved or planar the two-dimensional imaging sensor array 12 shown schematically as the device layer 402. The scintillator layer 404 may be directly under (e.g., directly connected to) the substantially planar top cover 312, and the imaging array 402 may be directly under the scintillator 404. Alternatively, a flexible layer 406 may be positioned between the scintillator layer 404 and the top cover 312 as part of the multilayer structure to allow adjustable curvature of the multilayer structure and/or to provide shock absorption. The flexible layer 406 may be selected to provide an amount of flexible support for both the top cover 312 and the scintillator 404, and may comprise a foam rubber type of material. The layers just described comprising the multilayer structure each may generally be formed in a rectangular shape and defined by edges arranged orthogonally and disposed in parallel with an interior side of the edges 318 of the housing 314, as described in reference to FIG. 3.

A substrate layer 420 may be disposed under the imaging array 402, such as a rigid glass layer, in one embodiment, or flexible substrate comprising polyimide, or a carbon fiber layer, upon which the array of photosensors 402 may be formed to allow adjustable curvature of the array, and may comprise another layer of the multilayer structure. Under the substrate layer 420 a radio-opaque shield layer 418 may be used as an x-ray blocking layer to help prevent scattering of x-rays passing through the substrate layer 420 as well as to block x-rays reflected from other surfaces in the interior volume 450. Readout electronics, including the scanning circuit 28, the read-out circuit 30, the bias circuit 32, and processing system 34a (all of FIG. 1) may be formed adjacent the imaging array 402 or, as shown, may be disposed below frame support member 416 in the form of integrated circuits (ICs) electrically connected to printed circuit boards 424, 425. The imaging array 402 may be electrically connected to the readout electronics 424 (ICs) over a flexible connector 428 which may comprise a plurality of flexible, sealed conductors known as chip-on-film (COF) connectors.

X-ray flux may pass through the radiolucent top panel cover 312, in the direction represented by an exemplary x-ray beam 16, and impinge upon scintillator 404 where stimulation by the high-energy x-rays 16, or photons, causes the scintillator 404 to emit lower energy photons as visible light rays which are then received in the photosensors of imaging array 402. The frame support member 416 may connect the multilayer structure to the housing 314 and may further operate as a shock absorber by disposing elastic pads (not shown) between the frame support beams 422 and the housing 314. Fasteners 410 may be used to attach the top cover 312 to the housing 314 and create a seal therebetween in the region 430 where they come into contact. In one embodiment, an external bumper 412 may be attached along the edges 318 of the DR detector 400 to provide additional shock-absorption.

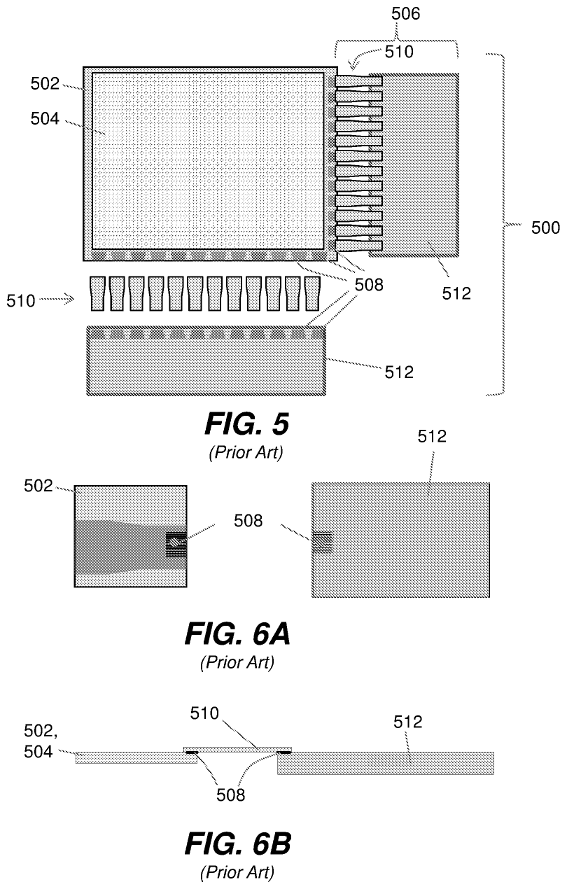

FIG. 5 illustrates one embodiment of a portion of a prior art digital radiographic detector 500 having an array of photosensors 504 formed on a glass substrate 502. The detector 500 also has attached thereto a plurality of flexible electronic circuits 510 used to connect the detector array 504 to image processing electronics 512 such as PWBs or printed circuit boards (PCBs). The lower portion of FIG. 5 shows an exploded view of bond pads 508 formed on the glass panel 502, on the PWB 512, and on a side of the chip-on-flex (COF) connectors 510 (not shown) facing away from the viewer. The bond pads 508 on the glass substrate 502 and on the PWB 512 serve as terminal electrical connection points into the array 504 and into the PWB control electronics, respectively. The COFs 510 electrically connect the bond pads 508 on the glass substrate 502 to the bond pads 508 on the PWBs 512. The right side of FIG. 5 illustrates a fully assembled configuration 506 of the components just described. One embodiment of the flexible electronic circuits, the COFs 510, are described in relation to the flexible connector 428 of FIG. 4. The COFs are electrically bonded to, for example, data lines and gate lines of the array 504 which have terminal points in the bond pads 508 on the glass substrate 502 of the radiographic detector array 504. One embodiment of the detector array 504 is described herein with respect to the photosensor cell array 212 of FIG. 2.

FIG. 6A illustrates a schematic close-up top view of an individual bonding pad 508 on the glass substrate 502 and on the PWB 512, used to connect, for example, a portion of the read-out circuitry in the PWB to a portion of the glass based x-ray detector sensor array 502 via the COF 510. FIG. 6A illustrates the bond pads 508 on the glass substrate 502 and on the PWB 512 containing a plurality of conductors that are electrically connected (bonded) to another corresponding plurality of conductors. FIG. 6B is a schematic side view showing, as described herein, the bond pads 508 on the glass substrate 502, on the COFs 510, and on the PWB 512 electrically connected to form an operative electronic control system over the photosensor array 504. In the event of a malfunctioning electrical connection or of a defective component, a repair procedure for the illustrated portion of the digital radiographic detector 500 might entail removing one or more of the plurality of COFs 510 from the PWB 512 and from the detector substrate 502; then reattaching the detached COFs 510, or one or more replacement COFs, to the glass substrate array 504 and PWB 512, or replacement PWB.

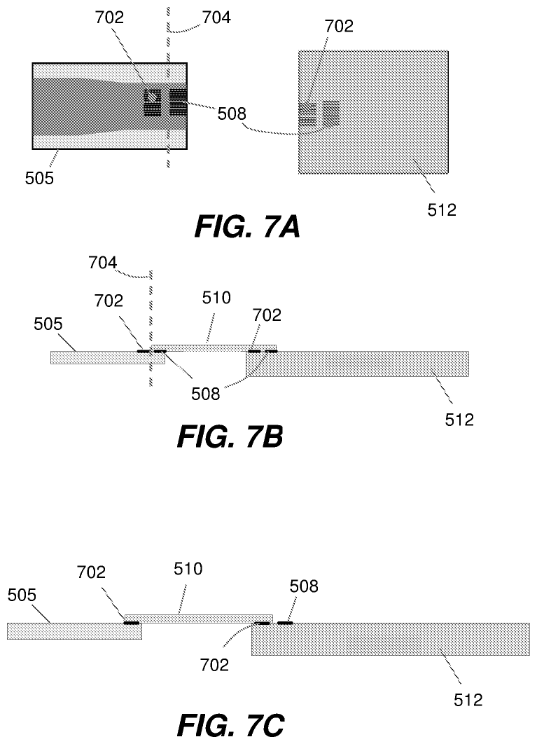

FIG. 7A illustrates a schematic top view close-up of an individual exemplary initial bond pad 508 and one redundant individual bond pad 702 on the flexible substrate 505 and one individual exemplary initial bond pad 508 and one individual redundant bond pad 702 on the PWB 512. FIGS. 7B-7C are two side views of the initial bond pads 508 and redundant bond pads 702 on the PWB 512 side, on the COFs 510, and on the flexible substrate 505 array side. In the event that a malfunctioning electrical connection or component is present, in one embodiment the initial bonding pads 508 are cut off along cut line 704 from the flexible substrate 505 array side (FIGS. 7A-7B), and the COF 510 is removed from the cut-off portion of the flexible substrate 505 and from the PWB 512. Initially, the COF 510 is electrically connected to the initial bonding pads 508 on the flexible substrate 505 and the PWB 512. After the flexible substrate 505 is cut off at cut line 704, the detached COF 510 is shifted to the left (as seen in FIGS. 7B-7C) and is reattached to redundant pads 702 on the PWB 512 and on the flexible substrate 505. In one embodiment, the PWB 512 side does not include redundant bond pads 702, the flexible substrate 505 array is cut along line 704 and one end of the COF 510 is detached from the cut-off portion of the flexible substrate 505 array and reattached to the redundant bond pads 702 on the flexible substrate 505, while remaining electrically connected to the PWB 512 bond pads 508 throughout. In one repair embodiment, the COF 510 is detached at both ends, the used bonding pad 508 on the flexible substrate array 505 is cut off at cut line 704, and a new PWB 512 and/or a new COF 510 is reattached to the flexible substrate 505 array using redundant pads 702 on the flex substrate 505 and on the PWB 512.

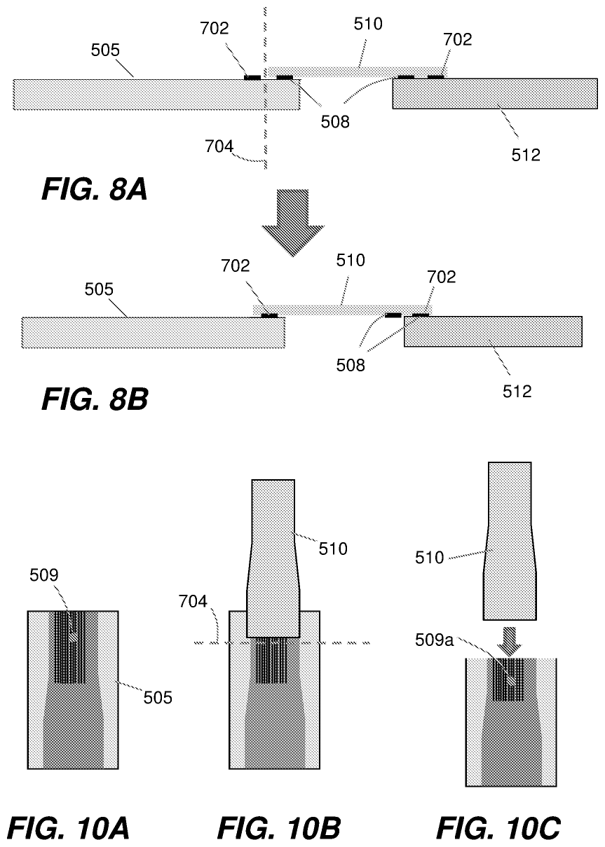

FIGS. 8A-8B illustrate in schematic side views a repair embodiment whereby initial bond pads 508 and redundant electrical bond pads 702 are disposed on one (PWB) end of the COFs 510 and on the flexible substrate 505. The PWB 512 includes one bond pad 508 initially connected to the bond pad 508 on the COF 510 (FIG. 8A). The initial bond pads 508 on the flexible substrate 505 are cut-off along cut line 704 and are discarded; the COFs 510 are detached from the cut-off portion and from the PWB 512, shifted to the left (in the view of FIG. 8B) and are reattached to the redundant pad 702 on the flexible substrate 505 array. The redundant pad 702 on the COF 510 is used to electrically reconnect (bond) the COF 510 to the bond pad 508 on the PWB 512, while the bond pad 508 on the COF 510 remains unconnected (FIG. 8B).

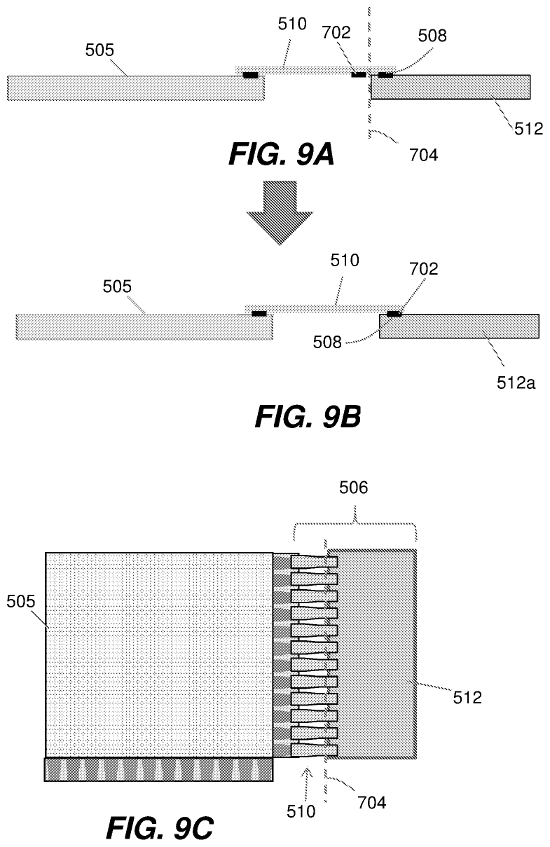

FIGS. 9A-9C illustrate two schematic side views (FIGS. 9A-9B) and a schematic top view (FIG. 9C) of an alternative repair embodiment to replace a PWB 512. Initial bond pads 508 on the COFs 510 (FIG. 9A) are all cut off from the COFs 510 along cut line 704 and the remaining redundant bond pads 702 on the COFs 510 are used to reconnect to a replacement PWB 512a. The replacement PWB 512a may include one bond pad 508 for each COF 510 or it may also be formed with redundant bond pads 702 as described herein. The COFs 510 initial bond pads 508 may be removed simultaneously from several COFs 510 as shown in FIGS. 9A, 9C, or they may be individually removed using an individual cut.

FIGS. 10A-10C illustrate an alternative repair embodiment whereby one or more bonding pads 509 may be formed on a flexible substrate 505 having electrical conductors formed in an elongated fashion (FIG. 10A) whereby a length of the bonding pad conductors are formed to be longer than a conventional standard length. In this repair embodiment, a portion of the elongated bonding pad 509 conductors may be cut along cut line 704 (FIG. 10B) leaving a bonding pad portion 509a having sufficient area to be reconnected to the previously connected COF 510 or a replacement COF. After the COF 510 is separated from the cut off bonding pad portion, it, or a replacement COF, may be reconnected to the remaining portion of the bonding pad 509a (FIG. 10C).

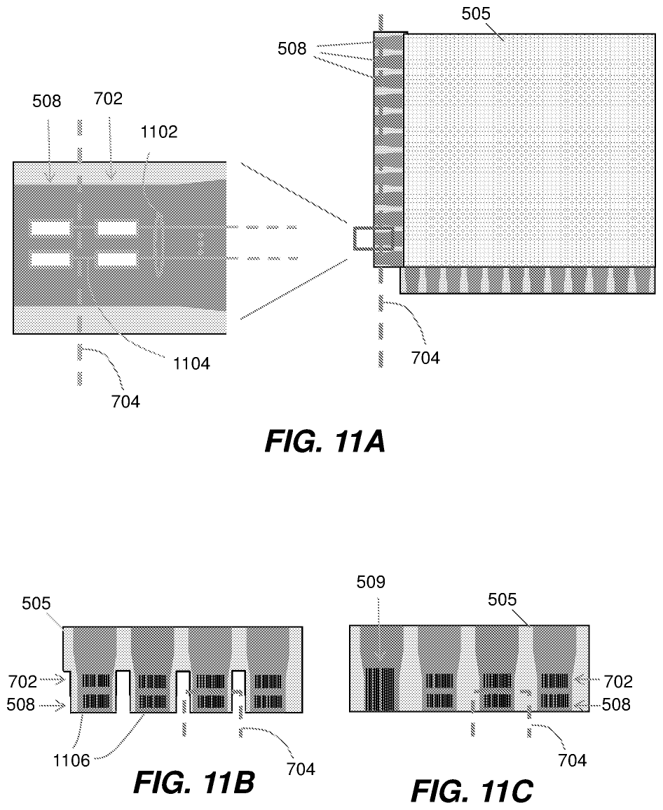

FIG. 11A illustrates a portion of a digital radiographic detector formed with a flexible substrate 505 array electrically connected to a plurality of bond pads 508. One of the bond pads is shown enlarged at the left of FIG. 11A. In one embodiment, initial bond pads 508 and redundant bond pads 702 may be formed. The initial bond pads 508 and the redundant bond pads 702 may be formed along parallel linear axes so that a single cut along cut line 704, which is parallel to the two linear axes of the bond pads, may be used to remove one or all of the initial bond pads 508 while leaving the redundant bond pads 702 intact. The bond pads 508 and 702 include terminal ends of electrical conductors that may include gate lines and data lines 1102 that may terminate in bonding pads having narrowed regions (necks) 1104 to improve a cutting procedure along exemplary cut line 704 for removing initial bond pads 508 to prevent electrical shred in the conductors of the pad. The flexible substrate 505 may be cut along its entire length along cut line 704 to remove and replace a defective PWB connected to bond pads 508, for example. FIG. 11B illustrates an embodiment of a bonding pad 508, 702, whereby the bonding pads 508, 702 may be formed on a flexible substrate 505 having individual extensions (fingers) 1106 for each bonding pad 508, 702. A cutting tool may be used for cutting individual fingers 1106 along cut line 704 (FIG. 11B) to remove the initial bonding pad 508 only from one finger 1106. FIG. 11C illustrates an embodiment where the flexible substrate 505 includes a continuous straight edge whereon the bonding pads 508, 702, are formed. A cutting tool may be used for cutting off an individual initial bonding pad 508 along U-shaped cut line 704 (FIG. 11C). An elongated bonding pad 509 may be formed (FIG. 11C), as described herein with reference to FIG. 10A, rather than forming a redundant bonding pad 702 thereon. The cutting tool used to cut the U-shaped cut line 704 may be used to remove a portion of the elongated bond pad 509 as described herein. The same cutting tool used to cut the U-shaped cut line 704 may be also be used to remove bonding pads 508 on individual fingers 1106 as described in relation to FIG. 11B. The step of cutting off an initial bonding pad 508 may be performed on a selected one or more individual bond pads of any of the embodiments described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A digital detector comprising:
an array of photosensors formed on a substrate;
a plurality of pairs of bonding pads formed on the substrate, each pair of bonding pads electrically connected to a same portion of the array of photosensors;
a plurality of COFs each configured to be electrically connectible to only one bonding pad in each pair of bonding pads; and
readout electronics electrically connected to the plurality of COFs to control a readout from the array of photosensors and to receive image data from the array of photosensors.

2. The detector of claim 1, wherein each pair of bonding pads is electrically connected to each other.

3. The detector of claim 1, wherein each pair of bonding pads includes a bonding pad configured to be removed by cutting through the substrate, and wherein each pair of bonding pads includes a bonding pad configured to be electrically connected to one of the plurality of COFs after its paired bonding pad is removed.

4. The detector of claim 3, wherein a portion of the substrate is removed corresponding to the removed bonding pad.

5. The detector of claim 2, wherein the removed portion of the substrate comprises an entire thickness of the substrate.

6. The detector of claim 2, wherein each pair of bonding pads comprises conductors having narrowed regions to facilitate cutting through the conductors.

7. The detector of claim 6, wherein the substrate is a flexible substrate made from a flexible material.

8. The detector of claim 1, wherein the plurality of pairs of bonding pads are formed along two linear axes such that each bonding pad of each pair is formed on only one of the two linear axes.

9. A method of electrically connecting an array of photosensors to COFs, the method comprising:
forming the array of photosensors on a substrate;
forming a first bonding pad and a second bonding pad on the substrate, the first and second bonding pads electrically connected to a first portion of the photosensors;
electrically connecting the first bonding pad to a COF;
detaching the COF from the first bonding pad;
removing the first bonding pad from the substrate; and
electrically connecting the second bonding pad to the COF.

10. The method of claim 9, wherein the step of removing comprises cutting off the first bonding pad from the substrate.

11. The method of claim 10, wherein the step of removing comprises cutting off an entire thickness of the substrate whereon the first bonding pad is formed.

12. A method of electrically connecting an array of photosensors to COFs, the method comprising;
electrically connecting a photosensor-connected bonding pad to a COF;
detaching the COF from the photosensor-connected bonding pad;
removing a portion of the photosensor-connected bonding pad; and
electrically connecting the COF to a remaining portion of the photosensor-connected bonding pad.

13. The method of claim 12 wherein the step of removing comprises cutting off a portion of the first photosensor-connected bonding pad.

14. The method of claim 12, wherein the step of electrically connecting the COF to the read-out circuits comprises electrically connecting a first read-out-circuit-connected bonding pad to the COF, the first read-out-circuit-connected bonding pad electrically connected to a first set of read-out circuit conductors.

15. The method of claim 12, further comprising detaching the COF from the first read-out-circuit-connected bonding pad; and
electrically connecting a second read-out-circuit-connected bonding pad to the COF, the second read-out-circuit-connected bonding pad electrically connected to the first set of read-out circuit conductors.

16. The method of claim 12, further comprising forming first and second COF-connected bonding pads on the COF, removing the first COF-connected bonding pad from the COF, and using the second COF-connected bonding pad to electrically connect the COF to either a photosensor-connected bonding pad or to a read-out circuit connected bonding pad.

17. A digital detector comprising:
an array of photosensors formed on a substrate;
a plurality of array bonding pads formed on the substrate, each array bonding pad electrically connected to a portion of the array of photosensors;
a printed circuit board comprising a plurality of readout bonding pads, each readout bonding pad electrically connected to readout electronics on the printed circuit board; and
a plurality of COFs each comprising:
a first COF bonding pad proximate a first end of the COF, the first bonding pad configured to be electrically connectible to only one array bonding pad; and
second and third COF bonding pads proximate a second end of the COF opposite the first end, wherein the second and third bonding pads are configured such that only one is connectible to only one readout bonding pad.

18. The detector of claim 17, wherein the readout electronics are configured to receive image data from the array of photosensors via the array bonding pads, the first COF bonding pads, the readout bonding pads, and only one of the second and third COF bonding pads.
